(19) United States
(12) Patent Application Publication
(10) Pub. No.: US 2016/0038356 A1
(43) Pub. Date: Feb. 11, 2016

(54) WHEEL CHAIR WITH URINAL DEVICE

(71) Applicants: JEN-HUO YAO, Taichung City (TW); LIANG-CHU YAO, Taichung City (TW); HSIAO-CHANG YAO, Taichung City (TW); ZAI-FU YAO, Taichung City (TW); CHIH-MIN YAO, Taichung City (TW)

(72) Inventors: JEN-HUO YAO, Taichung City (TW); LIANG-CHU YAO, Taichung City (TW); HSIAO-CHANG YAO, Taichung City (TW); ZAI-FU YAO, Taichung City (TW); CHIH-MIN YAO, Taichung City (TW)

(21) Appl. No.: 14/887,337

(22) Filed: Oct. 20, 2015

Related U.S. Application Data
(63) Continuation-in-part of application No. 13/902,986, filed on May 28, 2013.

(51) Int. Cl. A61G 5/10; A61G 5/12

(52) U.S. Cl. CPC A61G 5/1002; A61G 5/12; A61G 2005/122; A61G 2005/125

(57) ABSTRACT

A wheel chair with urinal device includes a wheel chair a cushion connected thereto and the cushion has a hole. A drain pan with a slanted bottom wall is removably located beneath the cushion and a drain hole is defined through the lower front end of the slanted bottom wall. Multiple outlets defined in the support frame communicate with the space above the slanted bottom wall. A box is removably attached to the rear side of the backrest and has a collection unit and a cleaning unit received therein. The cleaning unit provides detergent to clean and flush the waste in the drain pan and collected in the collection unit. The user activates and controls the cleaning unit by operating a cleaning switch on the armrest.

### BACKGROUND OF THE INVENTION

1. Fields of the Invention

The present invention relates to a Continuation-In-Part application of applicant's former U.S. patent application Ser. No. 13/902,986, filed on May 28, 2013.

2. Descriptions of Related Art

The conventional bodily waste reception devices or the like known to applicant are respectively disclosed in U.S. Pat. No. 3,383,713, U.S. Pub. No. 2005/0060797, and U.S. Pub. No. 2007/0044222. All of the prior art disclosed are not designed for being cooperated with a wheel chair which allows the user to move from one place to another while the urinal device is still available and easily used.

The present invention intends to provide a wheel chair with urinal device to eliminate the shortcomings mentioned above.

### SUMMARY OF THE INVENTION

The present invention relates to a wheel chair with urinal device, and comprises a wheel chair having a backrest and a support frame which supports a cushion therein. The cushion has a hole defined therethrough. Multiple outlets are defined through the rear sidewall of the support frame. A drain pan is removably located beneath the cushion and has a slanted bottom wall which has a higher rear end and a lower front end. A drain hole is defined through the slanted bottom wall and located at the lower front end of the slated bottom wall. The hole of the cushion communicates with the drain hole. The multiple outlets communicate with the space above the slanted bottom wall. A box is removably attached to the rear side of the backrest by multiple securing members. The box has a lower room and an upper room. A collection unit is located in the lower room and has a collection container. A guide pipe is connected between the collection container and the rain pipe. A cleaning unit has a detergent container for receiving detergent therein. The detergent container is located in the lower room. A transmission pipe is connected between the detergent container and the multiple outlets.

Preferably, the cleaning unit has a cleaning switch connected to one of two armrests of the wheel chair. The cleaning switch controls the detergent in the detergent container to flow toward the transmission pipe.

Preferably, the detergent container has a supply sensor located at the lower portion thereof. The collection container has a leak sensor located at the higher portion thereof. A supply light is connected to the wheel chair and electrically connected to the supply sensor, and a leak light is connected to the wheel chair and electrically connected to the leak sensor.

Preferably, the lower room has a first motor received therein which is connected to the collection container. A connection pipe is connected between the first motor and a nozzle.

Preferably, the lower room has a second motor received therein which is connected between the detergent container and the transmission pipe.

The primary object of the present invention is to provide a wheel chair with a urinal device, wherein the drain pan, the cushion, the collection unit and the cleaning unit can be individually removed from the wheel chair.

Another object of the present invention is to provide a wheel chair with a urinal device, wherein the box is attached to the backrest and includes two rooms to receive the collection unit, the cleaning unit and the personal stuff.

Yet another object of the present invention is to provide a wheel chair with a urinal device, wherein the detergent in the cleaning container, and the waste in the collection container are monitored by sensors.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the wheel chair with the urinal device of the present invention;

FIG. 2 is an exploded view of the box and the wheel chair of the present invention;

FIG. 3 is an exploded view of the cushion, the drain pan and the wheel chair of the present invention;

FIG. 4 is a side cross sectional view to show the wheel chair with the urinal device of the present invention, and

FIG. 5 is a perspective view to show the wheel chair of the present invention, wherein the box is opened to show the upper room.

### DETAILED DESCRIPTION OF THE PREFERRED EMBODIMENT

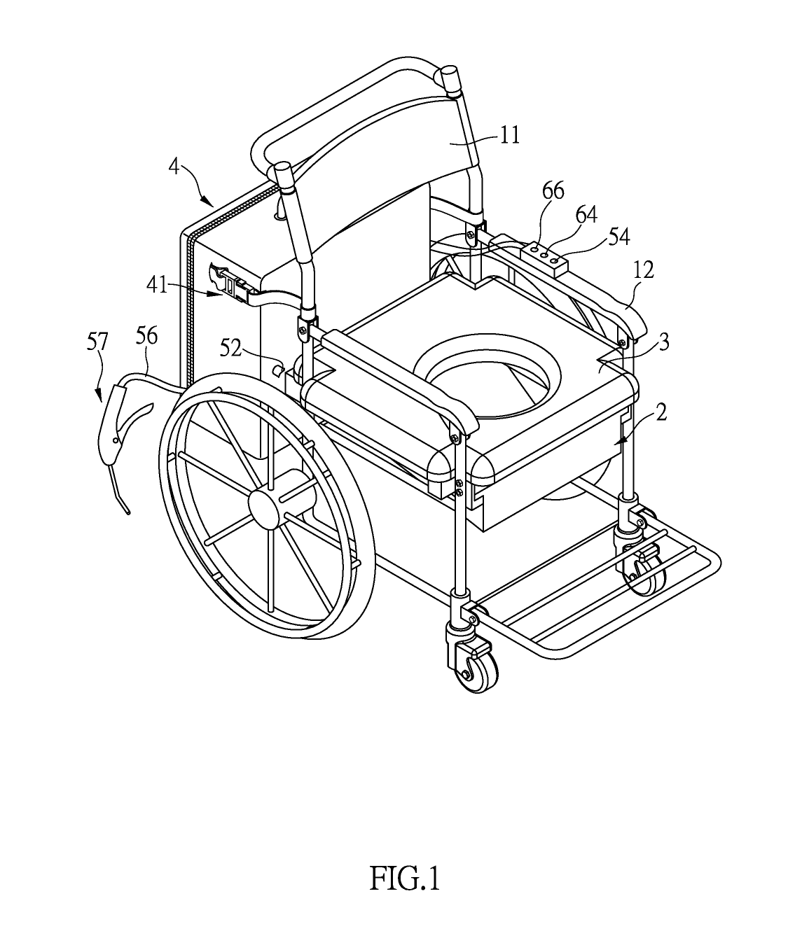

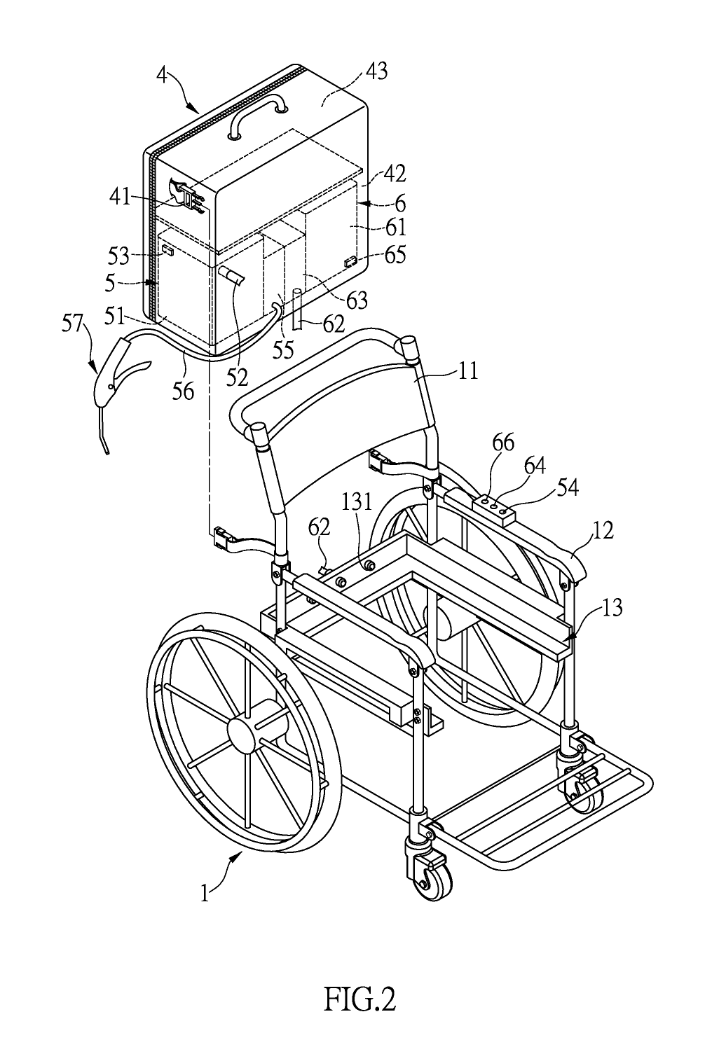

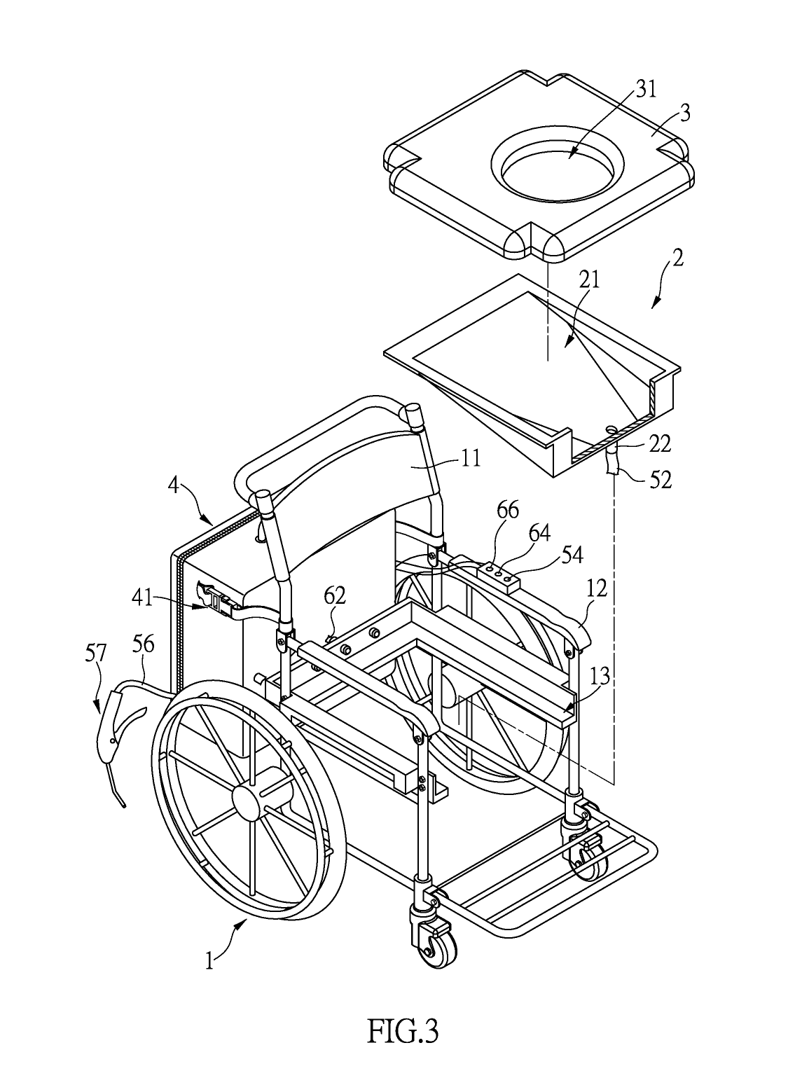

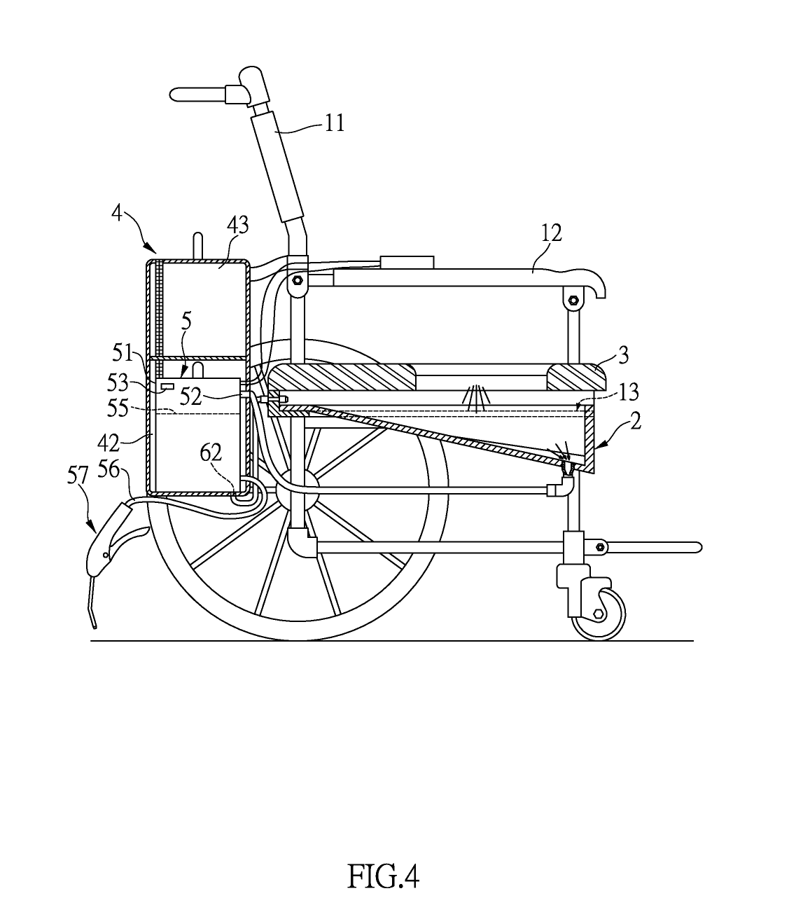

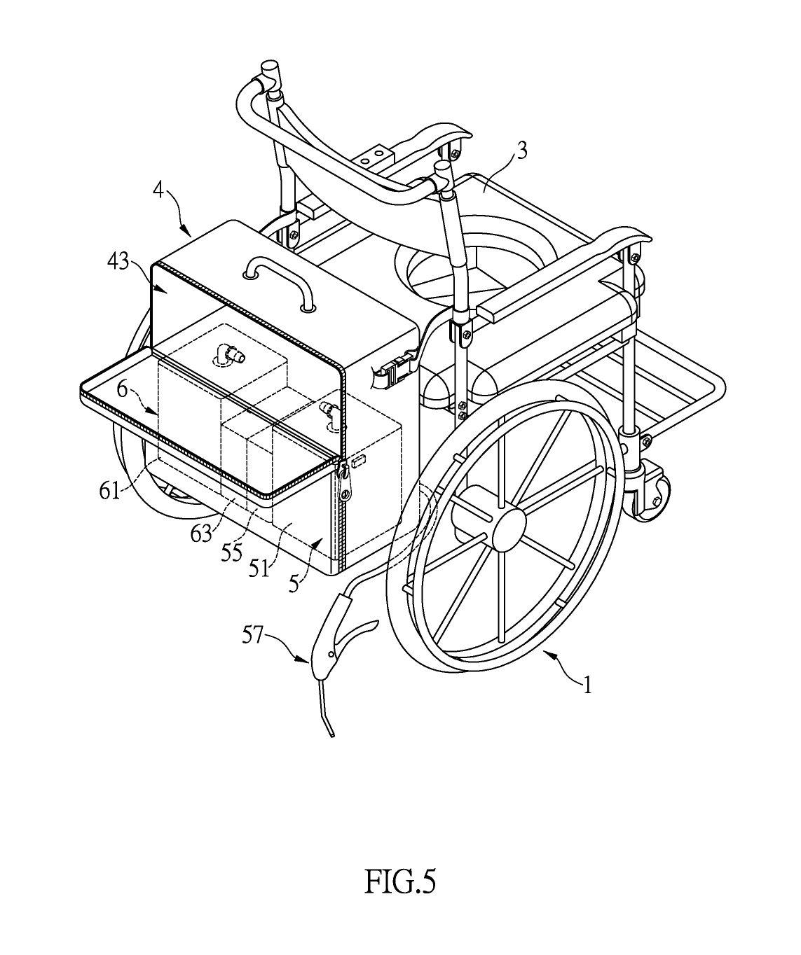

Referring to FIGS. 1 to 5, the wheel chair with urinal device of the present invention comprises a wheel chair 1 which comprises two side parts and each side part is connected with a rear wheel and a front wheel. A support frame is connected between the two side parts. A backrest 11 is connected between the two rear ends of the two side parts, and a handle is connected to the backrest 11. The support frame includes a U-shaped upright wall which has two sidewalls and a rear sidewall. Each of the two sidewalls and the rear sidewall has a horizontal flange extending therefrom. A cushion 3 is supported on the horizontal flanges and has a hole 31 defined therethrough. Multiple outlets 131 are defined through the rear sidewall of the support frame.

A drain pan 2 is removably located beneath the cushion 3 and has a slanted bottom wall 21 which has a higher rear end and a lower front end. A drain hole is defined through the slanted bottom wall 21 and located at the lower front end of the slated bottom wall 21. The hole 31 of the cushion communicates with the drain hole of the drain pan 2. The multiple outlets 131 communicate with the space above the slanted bottom wall 21.

A box 4 is removably attached to the rear side of the backrest 11 by multiple securing members 41. Each securing member 41 has one end secured to the post of each side part, and the other end of each securing member 41 has a snapping unit to be connected to the box 4. The box 4 has a lower room 42 and an upper room 43 defined therein. A cover is connected to the outside of the box 4 by a zipper so that the lower room 42 and the upper room 43 can be individually opened. The upper room 43 is used to store the user's personal stuff such as medicine, clothes and water bottles.

A collection unit 5 is located in the lower room 42 and has a collection container 51 and a guide pipe 52 which is connected between the collection container 51 and the drain pipe 22. A cleaning unit 6 is located in the lower room 42 and has a detergent container 61 for receiving detergent therein. A transmission pipe 62 is connected between the detergent container 61 and the multiple outlets 131.

The cleaning unit 6 further has a cleaning switch 64 connected to one of the two armrests of the wheel chair 1. The cleaning switch 64 is used to control the detergent in the detergent container 61 to flow toward the transmission pipe 62. The detergent container 61 has a supply sensor 65 connected to the lower portion thereof so as to detect the surface of the detergent in the detergent container 61. The collection container 51 has a leak sensor 53 connected to a higher portion thereof so as to prevent the waste reaches a higher position in the collection container 51.

A supply light 66 is connected to the armrest 12 of the wheel chair 1 and electrically connected to the supply sensor 65 so that when the supply sensor 65 connected to the lower portion of the detergent container 61 detects the surface of the detergent in the detergent container 61, the supply light 66 is turned on and the user is acknowledged to add detergent in the detergent container 61.

A leak light 54 is connected to the armrest 12 of the wheel chair 1 and electrically connected to the leak sensor 53. When the leak sensor 53 connected to the higher portion of the collection container 51 detects the surface of the collected waste in the collection container 51, the leak light 54 is turned on and the user is acknowledged to remove the waste from the collection container 51.

The lower room 42 has a first motor 55 received therein which is connected to the collection container 51, and a connection pipe 56 is connected between the first motor 55 and a nozzle 57. The lower room 42 has a second motor 63 received therein which is connected between the detergent container 61 and the transmission pipe 62.

When in use, the user operates the cleaning switch 64, the second motor 63 is activate to suck the detergent in the detergent container 61 to flush into the drain pan 2 via the transmission pipe 62 and the outlets 131, so that the waste in the drain pan 2 is flushed and drained into the guide pipe 52 via the drain hole of the rain pan 2. The waste is then collected into the collection container 51 via the guide pipe 52.

When the leak sensor 53 connected to the higher portion of the collection container 51 detects the surface of the collected waste in the collection container 51, the leak light 54 is turned on. The user is able to operate the first motor 55 which sucks the waste in the collection container 51, and the user guides the nozzle 57 into the toilet bowl and operates the nozzle 57, the waste in the collection container 51 is ejected into the toilet bowl via the connection pipe 56 and the nozzle 57, and is flushed away.

When the supply sensor 65 connected to the lower portion of the detergent container 61 detects the surface of the detergent in the detergent container 61, the supply light 66 is turned on and the user is acknowledged to add detergent in the detergent container 61.

The collection unit 5 and the cleaning unit 6 are located in the box 4 at the rear side of the backrest 11, and the user sits in the cushion 3 at the front of the wheel chair 1, so that the weight balance is achieved and the chair wheel 1 can be easily moved.

While we have shown and described the embodiment in accordance with the present invention, it should be clear to those skilled in the art that further embodiments may be made without departing from the scope of the present invention.

What is claimed is:

1. A wheel chair with urinal device, comprising:
a wheel chair having a backrest and a support frame which supports a cushion therein, the cushion having a hole defined therethrough, multiple outlets defined through a rear sidewall of the support frame;
a drain pan removably located beneath the cushion and having a slanted bottom wall which has a higher rear end and a lower front end, a drain hole defined through the slanted bottom wall and located at the lower front end of the slated bottom wall, the hole of the cushion communicating with the drain hole, the multiple outlets communicating with a space above the slanted bottom wall;
a box removably attached to a rear side of the backrest by multiple securing members, the box having a lower room and an upper room;
a collection unit having a collection container located in the lower room, a guide pipe connected between the collection container and the rain pipe, and
a cleaning unit having a detergent container for receiving detergent therein, the detergent container located in the lower room, a transmission pipe connected between the detergent container and the multiple outlets.

2. The wheel chair with urinal device as claimed in claim 1, wherein the cleaning unit further has a cleaning switch connected to one of two armrests of the wheel chair, the cleaning switch adapted to control the detergent in the detergent container to flow toward the transmission pipe.

3. The wheel chair with urinal device as claimed in claim 2, wherein the detergent container has a supply sensor located at a lower portion thereof, the collection container has a leak sensor located at a higher portion thereof, a supply light is connected to the wheel chair and electrically connected to the supply sensor, a leak light is connected to the wheel chair and electrically connected to the leak sensor.

4. The wheel chair with urinal device as claimed in claim 1, wherein the lower room has a first motor received therein which is connected to the collection container, a connection pipe is connected between the first motor and a nozzle.

5. The wheel chair with urinal device as claimed in claim 1, wherein the lower room has a second motor received therein which is connected between the detergent container and the transmission pipe.
